(19) United States
(12) Patent Application Publication
(10) Pub. No.: US 2017/0205865 A1
(43) Pub. Date: Jul. 20, 2017

(54) METHOD AND APPARATUS FOR ENERGY STORAGE VIRTUALIZATION

(71) Applicant: Electronics and Telecommunications Research Institute, Daejeon (KR)

(72) Inventors: Tae-In HWANG, Daejeon (KR); Il-Woo LEE, Daejeon (KR)

(21) Appl. No.: 15/410,400

(22) Filed: Jan. 19, 2017

(30) Foreign Application Priority Data
Jan. 20, 2016 (KR) 10-2016-0007054
Sep. 9, 2016 (KR) 10-2016-0116492

(51) Int. Cl. G06F 1/28; G06Q 50/06

(52) U.S. Cl. CPC G06F 1/28; G06Q 50/06

(57) ABSTRACT

Disclosed herein are an apparatus and method for energy storage virtualization. The apparatus for energy storage virtualization includes a virtual energy storage contract interface unit for processing or supporting conclusion of a contract of virtual energy storage, a virtual energy storage operation information service interface unit for managing information about mapping of physical energy storage devices to the virtual energy storage, and managing information about operation/management and settlement of the virtual energy storage, an energy storage virtualization main process unit for performing a function of controlling charge/discharge of the virtual energy storage and a function of settling profit derived from operation of the virtual energy storage, and an energy storage device control interface unit for performing interfacing so that the main process unit and the physical energy storage devices are operated in conjunction with each other to transmit and receive signals therebetween.

### CROSS REFERENCE TO RELATED APPLICATIONS

This application claims the benefit of Korean Patent Application Nos. 10-2016-0007054, filed Jan. 20, 2016 and 10-2016-0116492, filed Sep. 9, 2016, which are hereby incorporated by reference in their entirety into this application.

### BACKGROUND OF THE INVENTION

1. Technical Field

The present invention relates generally to energy storage of consumers and, more particularly, to a method and apparatus that virtualize multiple energy storage devices into a single integrated virtual energy storage system via energy storage virtualization, partition the integrated virtual energy storage system into units of virtual energy storages having logical energy storage capacity sizes without physical partitioning, and parcel out the units, thus allowing respective power management business operators and customers to easily own and manage their virtual energy storage without being subjected to the burden of direct equipment investment costs.

2. Description of the Related Art

On consumers' premises such as houses, buildings, and factories, the easiest method to reduce maximum power demand in the summer season or the winter season is a method of reducing the power consumption of load resources in buildings. However, in commercial facilities or factories, most load resources may be consuming resources that must be driven most of the time. Further, the energy consumed by air conditioning equipment accounts for a large part of the total energy consumed by a building. However, when these loads are controlled, the working environment or the like in the building may be deteriorated. For this reason, even if the reduction of loads is one method for reducing the maximum power demand, power consumption in the building may be effectively decreased by constructing in-house power-generating stations. However, even in this case, an energy storage device, which is one of power-generating stations that can be constructed in a building, requires high initial construction costs, and it is difficult to install such an energy storage device due to problems of insufficient space in small-scale buildings because of the large volume of the energy storage device itself.

### SUMMARY OF THE INVENTION

Accordingly, the present invention has been made keeping in mind the above problems occurring in the prior art, and an object of the present invention is to provide a method and apparatus for energy storage virtualization, which utilize a scheme in which a virtual energy storage unit corresponding to a required storage capacity is parceled out or leased to a consumer through an energy storage sales business operator who owns a large-scale energy storage device farm, thus reducing the consumer's maximum power demand, or in which the consumer participates in negawatt markets, small-scale distributed resource power markets, or Renewable Energy Certificate (REC) markets using surplus power, thus creating operation profit derived from power trading, rather than a conventional scheme in which energy-consuming consumers, such as for houses/buildings/factories, directly purchase energy storage devices, install the energy storage devices in corresponding buildings, and independently manage the energy storage devices.

The objects of the present invention are not limited to the above-described object, and other objects that are not described here will be clearly understood by those skilled in the art from the following description.

First, when the features of the present invention are summarized, an apparatus for energy storage virtualization according to an aspect of the present invention to accomplish the above object includes a virtual energy storage contract interface unit for processing conclusion of a contract for an use of a virtual energy storage; a virtual energy storage operation information service interface unit for managing information about mapping of physical energy storage devices to virtual energy storage, and managing information about operation/management and settlement of virtual energy storage, for which the contract has been concluded; an energy storage virtualization main process unit for performing a function of controlling charge/discharge of the virtual energy storage, for which the contract has been concluded, and a function of settling profit derived from operation of the virtual energy storage, based on setting of operation schemes of the virtual energy storage; and an energy storage device control interface unit for performing interfacing so that the energy storage virtualization main process unit and the physical energy storage devices are operated in conjunction with each other so as to transmit and receive signals required to control charge/discharge of the virtual energy storage and manage states of the virtual energy storage.

The apparatus may further include an energy storage virtualization information storage unit for storing information about the contract, information about the setting of the operation schemes, the information about the mapping, information about measurement of power generation and power consumption of the virtual energy storage, measured by the energy storage virtualization main process unit based on control of the charge/discharge, or information about the profit derived from the operation of the virtual energy storage, calculated by the energy storage virtualization main process unit depending on the profit settlement function.

The apparatus may process energy storage virtualization in such a way as to virtualize physical energy storage devices into an integrated virtual energy storage, partition the integrated virtual energy storage into virtual energy storages including the virtual energy storage having capacities corresponding to the contract, and manage the virtual energy storage, thus allowing respective consumers to own or manage corresponding virtual energy storage without being subjected to a burden of direct equipment investment costs.

The virtual energy storage contract interface unit may publicize information about power generation and capacities of the virtual energy storage and parcel prices and lease prices of the virtual energy storage via a web interface, and then provide a function to energy-consuming consumers so that the energy-consuming consumers conclude online the contract via the web interface.

The virtual energy storage operation information service interface unit may allocate spaces in energy storage devices so as to partition an integrated virtual energy storage system into a number of virtual energy storages, for which the contract has been concluded, manages the information about the mapping of the physical energy storage devices to the virtual energy storage, and provides the information about the operation/management and settlement of the virtual energy storage, for which the contract has been concluded, to respective consumers who subscribe to a service via a web interface.

The energy storage virtualization main process unit may include a virtual energy storage operation scheme setting/management unit for setting and managing operation schemes that include an operation for reducing a maximum power demand of each consumer depending on parceling-out or lease of the virtual energy storage, an operation for participating in a negawatt market, an operation for participating in a small-scale distributed resource power market, or an operation for participating in a Renewable Energy Certificate (REC) market; a virtual energy storage electricity meter management unit for managing execution of a electricity meter process for measuring power generation and power consumption of the virtual energy storage depending on charge/discharge of the energy storage devices, and managing information about measurement of power generation and power consumption of the virtual energy storage, measured by a electricity meter; a virtual energy storage charge/discharge control unit for controlling charge/discharge of the energy storage devices based on the set virtual energy storage operation schemes, and managing states of the energy storage devices; and a virtual energy storage operation profit settlement/management unit for settling and managing profit derived from the operation of the virtual energy storage based on the measurement information about the power generation and power consumption of respective virtual energy storages.

Further, a method for energy storage virtualization according to another aspect of the present invention includes processing conclusion of a contract for an use of a virtual energy storage, allocating spaces or capacities in the energy storage devices so as to partition an integrated virtual energy storage into a number of virtual energy storages including the virtual energy storage corresponding to storage capacity determined in the conclusion, and mapping information about the allocated storage spaces in the energy storage devices to the virtual energy storage, setting and managing operation schemes for the virtual energy storage in relation to the virtual energy storages partitioned, executing an electricity meter process for measuring the power generation and power consumption of the virtual energy storage based on the charge/discharge of the energy storage devices, controlling the charge/discharge of energy storage devices through the energy storage device control interface unit based on the virtual energy storage operation schemes, and managing the states of the energy storage devices, and settling and managing profit derived from the operation of the virtual energy storage based on the measurement information about power generation and power consumption of the virtual energy storage.

A predetermined storage unit may store information about the contract, information about the setting of the operation schemes, the information about the mapping, information about measurement of power generation and power consumption of the virtual energy storage, obtained by the process unit based on control of the charge/discharge, or information about the profit derived from the operation of the virtual energy storage, calculated by the process unit depending on the profit settlement function.

The method may process energy storage virtualization in such a way as to virtualize physical energy storage devices into an integrated virtual energy storage, partition the integrated virtual energy storage into virtual energy storages including the virtual energy storage having capacities corresponding to the contract, and manage the virtual energy storage, thus allowing respective consumers to own or manage the virtual energy storage without being subjected to a burden of direct equipment investment costs.

Processing the conclusion of the contract may be configured to publicize information about power generation and capacities of the virtual energy storage and parcel prices and lease prices of the virtual energy storage via a web interface, and then provide a function to energy-consuming consumers so that the energy-consuming consumers conclude online the contract via the web interface.

Managing the mapping information, the operation/management information and the settlement information may be configured to allocate spaces in energy storage devices so as to partition an integrated virtual energy storage into a number of virtual energy storages, for which the contract has been concluded, to manage the information about the mapping of the physical energy storage devices to the virtual energy storage, and to provide the information about the operation/management and settlement of the virtual energy storage, for which the contract has been concluded, to consumers who subscribe to a service via a web interface.

Performing the function of controlling the charge/discharge of the virtual energy storage and the function of settling the profit may include setting and managing operation schemes that include an operation for reducing a maximum power demand of each consumer depending on parceling-out or lease of the virtual energy storage, an operation for participating in a negawatt market, an operation for participating in a small-scale distributed resource power market, or an operation for participating in a Renewable Energy Certificate (REC) market; managing execution of a electricity meter process for measuring power generation and power consumption of the virtual energy storage depending on charge/discharge of the energy storage devices, and managing information about measurement of power generation and power consumption of the virtual energy storage, measured by a electricity meter; controlling charge/discharge of the energy storage devices based on the set virtual energy storage operation schemes, and managing states of the energy storage devices; and settling and managing profit derived from the operation of the virtual energy storage based on the measurement information about the power generation and power consumption of the virtual energy storage.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram for explaining the concept of virtualization of energy storage according to an embodiment of the present invention;

FIG. 2 is a block diagram for explaining an apparatus for energy storage virtualization according to an embodiment of the present invention;

FIG. 3 is a flowchart for explaining the operation of the energy storage virtualization apparatus according to an embodiment of the present invention; and

FIG. 4 is a diagram for explaining an example of a method for implementing the energy storage virtualization apparatus according to an embodiment of the present invention.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. It should be noted that the same reference numerals are used to designate the same or similar elements throughout the drawings. In the following description of the present invention, detailed descriptions of known functions and configurations which are deemed to make the gist of the present invention obscure will be omitted.

Further, terms such as “first”, “second”, “A”, “B”, “(a)”, and “(b)” may be used to describe the components of the present invention. These terms are merely used to distinguish relevant components from other components, and the substance, sequence or order of the relevant components is not limited by the terms. Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not to be interpreted as having ideal or excessively formal meanings unless they are definitely defined in the present specification.

First, an apparatus and method for energy storage virtualization according to embodiments of the present invention may virtualize multiple physical energy storage devices into a single virtual energy storage system, partition the single virtual energy storage system into virtual energy storages having energy storage space sizes desired by respective consumers, and parcel out the virtual energy storage to the consumers, and may then provide the function of controlling the charge/discharge of the virtual energy storage based on operation schemes set by respective consumers and the function of settling profit derived from the operation of the virtual energy storage via the measurement of power generation and power consumption of respective virtual energy storages.

Hereinafter, a method and apparatus, which partition multiple energy storage devices into virtual energy storages having logical energy storage capacity sizes via the virtualization of energy storage without physical partitioning, and parcel out the virtual energy storage, and then allow respective power management business operators and customers to easily own and manage their virtual energy storage without being subject to the burden of direct equipment investment costs, will be described in detail with reference to the attached drawings, which show the embodiments of the present invention.

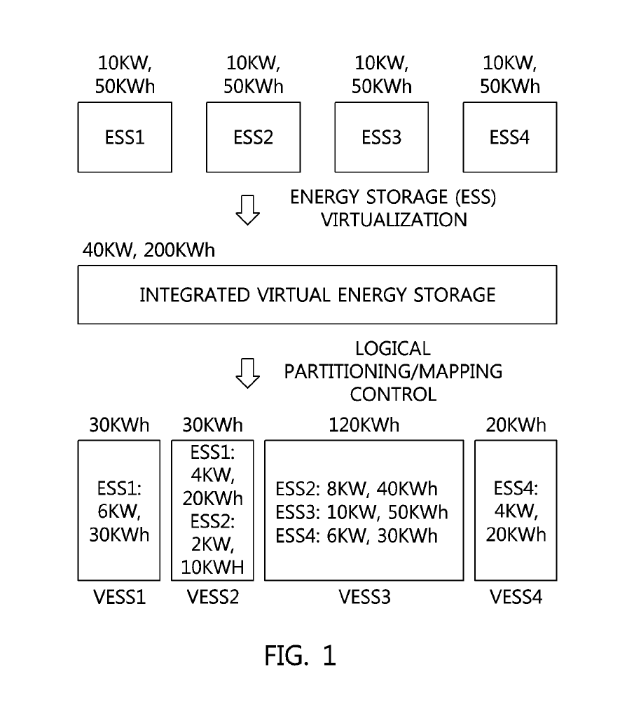

FIG. 1 is a diagram for explaining the concept of virtualization of energy storage according to an embodiment of the present invention. FIG. 1 illustrates the concept of virtualization of energy storage according to the present invention, which virtualizes multiple energy storage devices into a single integrated virtual energy storage system, logically partitions the integrated virtual energy storage system into virtual energy storages having energy storage capacity sizes desired by respective purchasers, and parcels out the virtual energy storage, and which then processes or supports the function of controlling the charge/discharge of the virtual energy storage that have been partitioned and parceled out based on operation schemes set by respective purchasers and the function of settling profit derived from the operation of the virtual energy storage via the measurement of power generation and power consumption of respective virtual energy storages.

For example, as shown in FIG. 1, it is assumed that four physical energy storage devices ESS1, ESS2, ESS3, and ESS4, each having a power of 10 KW and a charge/discharge capacity of 50 KWh, are virtualized into an integrated virtual energy storage system having a capacity of 200 KWh, and that the integrated energy storage device is then parceled out and leased to consumers. Here, it is assumed that virtual energy storage having capacities of 30 KWh (VESS1), 30 KWh (VESS2), 120 KWh (VESS3), and 20 KWh (VESS4) are respectively parceled out or leased to the consumers.

For the partitioning and management of individual spaces, the integrated virtual energy storage system (or the energy storage virtualization apparatus) may map 60% (6 KW, 30 KWh) of the capacity of ESS1 to the virtual energy storage VESS1, and may then manage the capacity. In the same way, 40% of the capacity (4 KW, 20 KWh) of ESS1 and 20% (2 KW, 10 KWh) of the capacity of ESS2 may be mapped to the virtual energy storage VESS2, and may then be managed. Further, 80% (8 KW, 40 KWh) of the capacity of ESS2, 100% (10 KW, 50 KWh) of the capacity of ESS3, and 60% (6 KW, 30 KWh) of the capacity of ESS4 may be mapped to the virtual energy storage VESS3, and may then be managed. Furthermore, 40% (4 KW, 20 KWh) of the capacity of ESS4 may be mapped to the virtual energy storage VESS4, and may then be managed.

Virtual electricity meter processes may be executed for respective virtual energy storages VESS1, VESS2, VESS3, and VESS4, so that power generated and consumed via the control of the charge/discharge of respective energy storage devices ESS1, ESS2, ESS3, and ESS4 may be measured, and profit derived from the operation of the virtual energy storages may be settled.

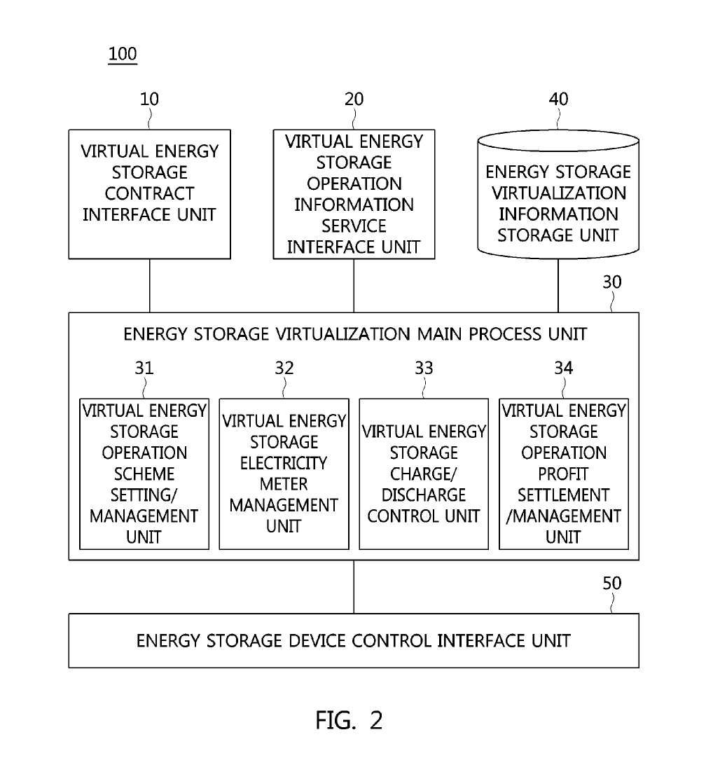

FIG. 2 is a block diagram showing an apparatus 100 for energy storage virtualization according to an embodiment of the present invention. The apparatus 100 for energy storage virtualization (hereinafter referred to as “energy storage virtualization apparatus 100”) according to the embodiment of the present invention may virtualize multiple physical energy storage devices (see ESS1, ESS2, ESS3, and ESS4 of FIG. 1) into a single integrated virtual energy storage system, logically partition the integrated energy storage device into virtual energy storages having energy storage space sizes desired by respective purchasers, parcel out the virtual energy storage to the purchasers, control the charge/discharge of the virtual energy storage (see VESS1, VESS2, VESS3, and VESS4 of FIG. 1) based on operation schemes set by the respective purchasers, and settle profit derived from the operation of the virtual energy storage via the measurement of power generation and power consumption of respective virtual energy storage units.

Referring to FIG. 2, the energy storage virtualization apparatus 100 according to the embodiment of the present invention is configured to partition multiple energy storage devices into virtual energy storages having logical energy storage capacity sizes via the virtualization of energy storage without physical partitioning, and parcel out the virtual energy storage, thus allowing respective power management business operators and customers to easily own and manage their virtual energy storage without being subject to the burden of direct equipment investment costs. Further, the energy storage virtualization apparatus 100 includes a virtual energy storage contract interface unit 10, a virtual energy storage operation information service interface unit 20, an energy storage virtualization main process unit 30, an energy storage virtualization information storage unit 40, and an energy storage device control interface unit 50. The energy storage virtualization main process unit 30 includes a virtual energy storage operation scheme setting/management unit 31, a virtual energy storage electricity meter management unit 32, a virtual energy storage charge/discharge control unit 33, and a virtual energy storage operation profit settlement/management unit 34. The energy storage virtualization apparatus 100 may be operated by an energy storage sales business operator.

The individual components of the energy storage virtualization apparatus 100 according to the embodiment of the present invention may be implemented as hardware such as a semiconductor processor, software such as an application program, or a combination thereof. Also, the energy storage virtualization main process unit 30, which takes charge of an overall control operation, may be implemented to include the functions of one or more of other components, and may enable some functions of the energy storage virtualization main process unit 30 to be implemented as separate components in other units.

The virtual energy storage contract interface unit 10 publicizes information about the power generation and capacities of virtual energy storage and information about the parcel prices and lease prices of the virtual energy storage via a web interface (not shown) for access to the Internet, and then provide a function to energy-consuming consumers such as those operating houses/building/factories so that the energy-consuming consumers may conclude a contract with energy storage sales business operators.

The virtual energy storage operation information service interface unit 20 allocates the spaces (or capacities) in the energy storage devices so as to partition the integrated virtual energy storage system into a number of virtual energy storages, for which parceling-out contracts or lease contracts have been concluded by the virtual energy storage contract interface unit 10, maps information about the allocation of the storage spaces in the energy storage devices to the corresponding virtual energy storage, and provides information about the operation/management and settlement of the virtual energy storages, for which the contract has been concluded, to consumers that subscribe to the service via the web interface.

The energy storage virtualization main process unit 30 performs the function of controlling the charge/discharge of the virtual energy storage, for which a contract has been concluded by the virtual energy storage contract interface unit 10, and the function of settling profit derived from the operation of the virtual energy storage depending on the setting of operation schemes of the virtual energy storage.

The energy storage virtualization information storage unit 40 stores information about the contract of the virtual energy storage, information about the setting of the operation schemes, information about the mapping of physical energy storage devices to virtual energy storage, information about the measurement of power generation and power consumption of the virtual energy storage, and information about the settlement of profit derived from the operation of the virtual energy storage.

The energy storage device control interface unit 50 performs interfacing so that the energy storage virtualization main process unit 30 and each energy storage device are operated in conjunction with each other, and may also perform interfacing so that control signals required to control the charge/discharge of virtual energy storage and manage the states of the virtual energy storage are mutually transmitted and received therebetween.

The virtual energy storage operation scheme setting/management unit 31 of the energy storage virtualization main process unit 30 sets and manages operation schemes, such as the operation of reducing the maximum power demand of each consumer depending on the parceling-out or lease of a virtual energy storage (e.g. whether to reduce the maximum power demand, the amount of power to be reduced, etc.), the operation of participating in negawatt markets, the operation of participating in small-scale distributed resource power markets, and the operation of participating in REC markets.

The virtual energy storage electricity meter management unit 32 manages the execution of a electricity meter process for measuring power generation and power consumption of respective virtual energy storages depending on the control of the charge/discharge of respective energy storage devices, and manages measurement information measured by the electricity meter (i.e. information obtained by measuring the power generated and consumed by respective virtual energy storages).

The virtual energy storage charge/discharge control unit 33 controls the charge/discharge of the energy storage devices through the energy storage device control interface unit 50 based on the virtual energy storage operation schemes set by the virtual energy storage operation scheme setting/management unit 31 and manages the states of the energy storage devices.

The virtual energy storage operation profit settlement/management unit 34 performs the function of settling operation profit, thus settling and managing profit derived from the operation of the virtual energy storage based on the measurement information about power generation and power consumption of respective virtual energy storages, measured by the virtual energy storage electricity meter management unit 32.

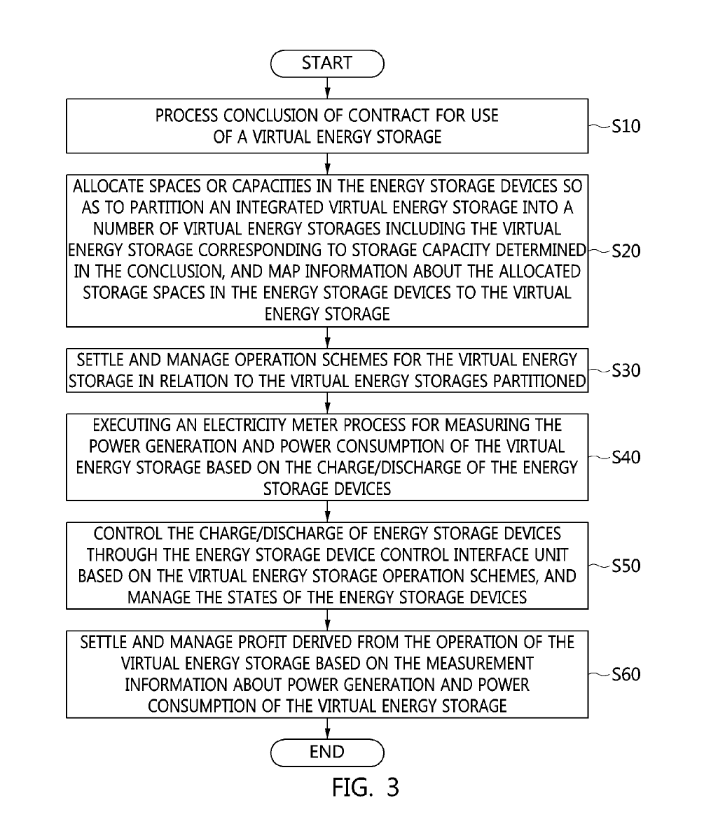

FIG. 3 is a flowchart for explaining the operation of the energy storage virtualization apparatus 100 according to an embodiment of the present invention. By means of the energy storage virtualization apparatus 100 according to the embodiment of the present invention, it is possible to partition multiple energy storage devices into virtual energy storages having logical energy storage capacity sizes via the virtualization of energy storage without physical partitioning, and parcel out the virtual energy storage, thus allowing respective power management business operators and customers to easily own and manage their virtual energy storage without being subjected to the burden of direct equipment investment costs.

For this function, referring to FIG. 3, the virtual energy storage contract interface unit 10 publicizes or advertises information about the power generation and capacities of virtual energy storage and information about the parcel prices and lease prices of the virtual energy storage via a web interface (not shown), and may provide a function to consumers such as those operating houses/building/factories so that the consumers may enter online information required for the parceling-out or lease of virtual energy storage and may conclude a contract with energy storage sales business operators at step S10. The information about the contract for an use of the virtual energy storage may be stored and managed in the energy storage virtualization information storage unit 40.

At step S20, the virtual energy storage operation information service interface unit 20 allocates spaces (or capacities) in the energy storage devices so as to partition an integrated virtual energy storage system into a number of virtual energy storage corresponding to storage capacity determined in the conclusion at step S10, and maps information about the allocated storage spaces in the energy storage devices to the corresponding virtual energy storage. The information about the mapping of the physical energy storage devices to the virtual energy storage is stored and managed in the energy storage virtualization information storage unit 40.

In relation to the virtual energy storages partitioned at step S20, the virtual energy storage operation scheme setting/management unit 31 of the energy storage virtualization main process unit 30 sets and manages operation schemes for the virtual energy storage, such as the operation of reducing the maximum power demand of each consumer depending on the parceling-out or lease of the virtual energy storage (e.g. whether to reduce the maximum power demand, the amount of power to be reduced, etc.), the operation of participating in negawatt markets, the operation of participating in small-scale distributed resource power markets, and the operation of participating in REC markets at step S30. Information about the setting of the corresponding operation schemes is stored and managed in the energy storage virtualization information storage unit 40.

Next, the virtual energy storage electricity meter management unit 32 executes a electricity meter process for measuring the power generation and power consumption of respective virtual energy storages based on the charge/discharge of respective energy storage devices at step S40. Measurement information measured by the electricity meter (i.e. information obtained by measuring power generated and consumed by respective virtual energy storages) is stored and managed in the energy storage virtualization information storage unit 40.

The virtual energy storage charge/discharge control unit 33 controls the charge/discharge of energy storage devices through the energy storage device control interface unit 50 based on the virtual energy storage operation schemes set by the virtual energy storage operation scheme setting/management unit 31, and manages the states of the energy storage devices at step S50.

At step S60, the virtual energy storage operation profit settlement/management unit 34 settles and manages profit derived from the operation of the virtual energy storage based on the measurement information about power generation and power consumption of respective virtual energy storages, measured by the virtual energy storage electricity meter management unit 32. Information about the settlement of the operation profit of the virtual energy storage is stored and managed in the energy storage virtualization information storage unit 40.

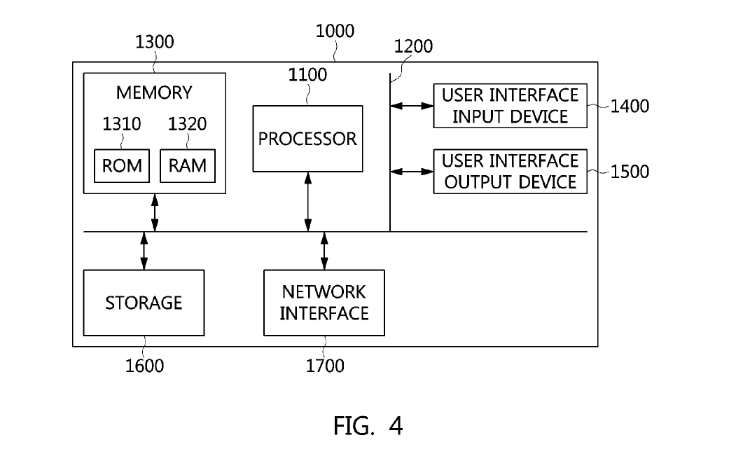

FIG. 4 is a diagram for explaining an example of a method for implementing the energy storage virtualization apparatus 100 according to an embodiment of the present invention. The energy storage virtualization apparatus 100 according to the embodiment of the present invention may be implemented as hardware, software or a combination thereof. For example, the energy storage virtualization apparatus 100 may be implemented as a computing system 1000, such as that shown in FIG. 4.

The computing system 1000 may include at least one processor 1100, memory 1300, a user interface input device 1400, a user interface output device 1500, storage 1600, and a network interface 1700, which are connected to each other through a bus 1200. The processor 1100 may be either a Central Processing Unit (CPU) or a semiconductor device for executing instructions stored in the memory 1300 and/or the storage 1600. Each of the memory 1300 and the storage 1600 may include any of various types of volatile or nonvolatile storage media. For example, the memory 1300 may include Read Only Memory (ROM) 1310 and Random Access Memory (RAM) 1320.

Therefore, steps of the method or the algorithm described in relation with the embodiments disclosed in the present specification may be directly implemented by a hardware module or a software module that is executed by the processor 1100 or by a combination of the two types of modules. The software module may reside in a storage medium (i.e. the memory 1300 and/or the storage 1600), such as RAM, flash memory, ROM, Erasable Programmable ROM (EPROM), Electrically Erasable Programmable ROM (EEPROM), a register, a hard disk, a removable disk, or a Compact Disk (CD)-ROM. An exemplary storage medium may be coupled to the processor 1100, and the processor 1100 may read information from the storage medium and write information to the storage medium. Alternatively, the storage medium may be integrated with the processor 1100. The processor and the storage medium may also reside in an Application-Specific Integrated Circuit (ASIC). The ASIC may reside in a user terminal. Alternatively, the processor and the storage medium may reside as individual components in the user terminal.

As described above, the energy storage virtualization apparatus 100 according to the present invention, which can be operated by an energy storage sales business operator who possesses a large-scale energy storage device farm, may virtualize multiple energy storage devices into a single integrated virtual energy storage via the virtualization of energy storage, partition the integrated virtual energy storage into virtual energy storages having logical energy storage capacity sizes without physical partitioning, and parcel out the virtual energy storage, thus allowing power management business operators, customers, or other consumers to easily own and manage their virtual energy storage without being subjected to the burden of direct equipment investment costs. For energy storage capacity that is partitioned and provided, it is possible for each consumer to control and manage the charge and discharge of the corresponding energy storage based on a desired operation scheme.

That is, in a smart grid environment, it is difficult in practice for small-scale consumers to independently construct an energy storage device, which is one of power generating stations that can be constructed in a building, due to problems such as high initial construction costs and the acquisition of installation spaces, contracts with resident families in the case of multi-family residential buildings, and the requirement for continuous management. Therefore, a business operator for parceling-out and leasing energy storage, who constructs a large-scale energy storage farm, partitions it into virtual energy storages having energy storage capacities required by consumers, and parcels out or leases the virtual energy storage, is required. Accordingly, the present invention provides an energy storage virtualization apparatus and method for such energy storage parceling and lease business operators, so that consumers, to whom virtual energy storage corresponding to required storage capacities are parceled out or leased, may reduce their basic electricity bills by decreasing the maximum power demand, and may create value-added benefits by participating in various power trading markets, such as negawatt markets, small-scale distributed resource power markets, and REC markets, using surplus power.

In particular, the present invention may parcel out power generation capacity and energy storage capacity at the size desired by each purchaser via the virtualization of energy storage in a smart-grid environment. Accordingly, the present invention may parcel out virtual energy storage spaces to consumers, such as power customers or power management business operators who encounter difficulty in directly investing in distributed power generation resources, such as energy storage devices (ESS) or photovoltaic power generation, due to high initial investment costs, and may control the virtual energy storage spaces based on desired operation schemes, thus reducing electricity bills and the basic electricity prices of users. In addition, the consumers may sell surplus power via negawatt markets or small-scale distributed resource power markets, thus creating sales profits.

In accordance with the method and apparatus for energy storage virtualization according to the present invention, there are advantages in that an energy storage sales business operator who owns a large-scale energy storage device farm may virtualize energy storage devices into a single integrated virtual energy storage system via the virtualization of energy storage, partition the integrated virtual energy storage system into virtual energy storages having logical energy storage capacity sizes without physical partitioning, and parcel out the virtual energy storage, thus allowing power management business operators, customers, or other consumers to easily own and manage their virtual energy storage without being subjected to the burden of direct equipment investment costs. For energy storage capacity that is partitioned and provided, it is possible for each consumer to control and manage the charge and discharge of the corresponding energy storage based on a desired operation scheme.

That is, in a smart grid environment, it is difficult in practice for small-scale consumers to independently construct an energy storage device, which is one of power generating stations that can be constructed in a building, due to problems such as high initial construction costs and the acquisition of installation spaces, contracts with resident families in the case of multi-family residential buildings, and the requirement for continuous management. Therefore, a business operator for parceling-out and leasing energy storage, who constructs a large-scale energy storage farm, partitions it into virtual energy storages having energy storage capacities required by consumers, and parcels out or leases the virtual energy storages, is required. Accordingly, the present invention provides an energy storage virtualization apparatus and method for such energy storage parceling and lease business operators, so that consumers, to whom virtual energy storage corresponding to required storage capacities are parceled out or leased, may reduce their basic electricity bills by decreasing the maximum power demand, and may create value-added benefits by participating in various power trading markets, such as negawatt markets, small-scale distributed resource power markets, and REC markets, using surplus power.

In particular, the present invention may parcel out power generation capacity and energy storage capacity at the size desired by each purchaser via the virtualization of energy storage in a smart-grid environment. Accordingly, the present invention may parcel out virtual energy storage spaces to consumers, such as power customers or power management business operators who encounter difficulty in directly investing in distributed power generation resources, such as energy storage devices (ESS) or photovoltaic power generation, due to high initial investment costs, and may control the virtual energy storage spaces based on desired operation schemes, thus reducing electricity bills and the basic electricity prices of users. In addition, the consumers may sell surplus power via negawatt markets or small-scale distributed resource power markets, thus creating sales profits.

Although the preferred embodiments of the present invention have been disclosed for illustrative purposes, those skilled in the art will appreciate that various modifications and changes are possible, without departing from the essential features of the invention as disclosed in the accompanying claims.

Therefore, the embodiments disclosed in the present invention are not intended to limit the technical spirit of the present invention and are merely intended to describe the invention, and the scope of the technical spirit of the present invention is not limited by those embodiments. The protection scope of the present invention should be defined by the accompanying claims, and all technical spirit of the accompanying claims and equivalents thereof should be construed as being included in the scope of the present invention.

What is claimed is:

1. An apparatus for energy storage virtualization, comprising:
a virtual energy storage contract interface unit for processing conclusion of a contract for an use of virtual energy storage;
a virtual energy storage operation information service interface unit for managing information about mapping of physical energy storage devices to a virtual energy storage, and managing information about operation/management and settlement of virtual energy storage, for which the contract has been concluded;
an energy storage virtualization main process unit for performing a function of controlling charge/discharge of the virtual energy storage, for which the contract has been concluded, and a function of settling profit derived from operation of the virtual energy storage, based on setting of operation schemes of the virtual energy storage; and
an energy storage device control interface unit for performing interfacing so that the energy storage virtualization main process unit and the physical energy storage devices are operated in conjunction with each other so as to transmit and receive signals required to control charge/discharge of the virtual energy storage and manage states of the virtual energy storage.

2. The apparatus of claim 1, further comprising an energy storage virtualization information storage unit for storing information about the contract, information about the setting of the operation schemes, the information about the mapping, information about measurement of power generation and power consumption of the virtual energy storage, measured by the energy storage virtualization main process unit based on control of the charge/discharge, or information about the profit derived from the operation of the virtual energy storage, calculated by the energy storage virtualization main process unit depending on the profit settlement function.

3. The apparatus of claim 1, wherein the apparatus processes energy storage virtualization in such a way as to virtualize physical energy storage devices into an integrated virtual energy storage, partition the integrated virtual energy storage into virtual energy storages including the virtual energy storage having capacities corresponding to the contract, and manage the virtual energy storage, thus allowing respective consumers to own or manage the virtual energy storage without being subjected to a burden of direct equipment investment costs.

4. The apparatus of claim 1, wherein the virtual energy storage contract interface unit publicizes information about power generation and capacities of the virtual energy storage and parcel prices and lease prices of the virtual energy storage via a web interface, and then provides a function to energy-consuming consumers so that the energy-consuming consumers conclude online the contract via the web interface.

5. The apparatus of claim 1, wherein the virtual energy storage operation information service interface unit allocates spaces in energy storage devices so as to partition an integrated virtual energy storage system into a number of virtual energy storages, for which the contract has been concluded, manages the information about the mapping of the physical energy storage devices to the virtual energy storage, and provides the information about the operation/management and settlement of the virtual energy storage, for which the contract have been concluded, to respective consumers who subscribe to a service via a web interface.

6. The apparatus of claim 1, wherein the energy storage virtualization main process unit comprises:
a virtual energy storage operation scheme setting/management unit for setting and managing operation schemes that include an operation for reducing a maximum power demand of each consumer depending on the use of the virtual energy storage, an operation for participating in a negawatt market, an operation for participating in a small-scale distributed resource power market, or an operation for participating in a Renewable Energy Certificate (REC) market;
a virtual energy storage electricity meter management unit for managing execution of a electricity meter process for measuring power generation and power consumption of the virtual energy storage depending on charge/discharge of the energy storage devices, and managing information about measurement of power generation and power consumption of the virtual energy storage, measured by a electricity meter;
a virtual energy storage charge/discharge control unit for controlling charge/discharge of the energy storage devices based on the set virtual energy storage operation schemes, and managing states of the energy storage devices; and
a virtual energy storage operation profit settlement/management unit for settling and managing profit derived from the operation of the virtual energy storage based on the measurement information about the power generation and power consumption of virtual energy storage.

7. A method for energy storage virtualization, comprising:
processing conclusion of a contract of a virtual energy storage;
allocating spaces or capacities in the energy storage devices so as to partition an integrated virtual energy storage into a number of virtual energy storages including the virtual energy storage corresponding to storage capacity determined in the conclusion, and mapping information about the allocated storage spaces in the energy storage devices to the virtual energy storage;
setting and managing operation schemes for the virtual energy storage in relation to the virtual energy storages partitioned;
executing an electricity meter process for measuring the power generation and power consumption of the virtual energy storage based on the charge/discharge of the energy storage devices;
controlling the charge/discharge of energy storage devices through the energy storage device control interface unit based on the virtual energy storage operation schemes, and managing the states of the energy storage devices; and
settling and managing profit derived from the operation of the virtual energy storage based on the measurement information about power generation and power consumption of the virtual energy storage.

8. The method of claim 7, wherein a predetermined storage unit stores information about the contract, information about the setting of the operation schemes, the information about the mapping, information about measurement of power generation and power consumption of the virtual energy storage, obtained by the process unit based on control of the charge/discharge, or information about the profit derived from the operation of the virtual energy storage, calculated by the process unit depending on the profit settlement function.

9. The method of claim 7, wherein the method processes energy storage virtualization in such a way as to virtualize physical energy storage devices into an integrated virtual energy storage, partition the integrated virtual energy storage device into virtual energy storages including the virtual energy storage having capacities corresponding to the contract, and manage the virtual energy storage, thus allowing respective consumers to own or manage the virtual energy storage without being subjected to a burden of direct equipment investment costs.

10. The method of claim 7, wherein processing the conclusion of the contract is configured to publicize information about power generation and capacities of the virtual energy storage and parcel prices and lease prices of the virtual energy storage via a web interface, and then provide a function to energy-consuming consumers so that the energy-consuming consumers conclude online the contract via the web interface.

11. The method of claim 7, wherein managing the mapping information, the operation/management information and the settlement information is configured to allocate spaces in energy storage devices so as to partition an integrated virtual energy storage into a number of virtual energy storages, for which the contract has been concluded, to manage the information about the mapping of the physical energy storage devices to the virtual energy storage, and to provide the information about the operation/management and settlement of the virtual energy storage, for which the contract has been concluded, to consumers who subscribe to a service via a web interface.

12. The method of claim 7, wherein performing the function of controlling the charge/discharge of the virtual energy storage and the function of settling the profit comprises:
setting and managing operation schemes that include an operation for reducing a maximum power demand of each consumer depending on the use of the virtual energy storage, an operation for participating in a negawatt market, an operation for participating in a small-scale distributed resource power market, or an operation for participating in a Renewable Energy Certificate (REC) market;
managing execution of a electricity meter process for measuring power generation and power consumption of the virtual energy storage depending on charge/discharge of the energy storage devices, and managing information about measurement of power generation and power consumption of the virtual energy storage, measured by a electricity meter;
controlling charge/discharge of the energy storage devices based on the set virtual energy storage operation schemes, and managing states of the energy storage devices; and
settling and managing profit derived from the operation of the virtual energy storage based on the measurement information about the power generation and power consumption of the virtual energy storage.
